(19) United States
(12) Patent Application Publication
(10) Pub. No.: US 2016/0065537 A1
(43) Pub. Date: Mar. 3, 2016

(54) METHOD AND APPARATUS ENABLING INTEROPERABILITY BETWEEN DEVICES OPERATING AT DIFFERENT SECURITY LEVELS AND TRUST CHAINS

(71) Applicant: MOTOROLA SOLUTIONS, INC, Schaumburg, IL (US)

(72) Inventors: MICHAEL J. STELZNER, CHICAGO, IL (US); MOE M. BOUJI, STREAMWOOD, IL (US); RACHEL V. MICHELSON, GLENVIEW, IL (US)

(21) Appl. No.: 14/471,860

(22) Filed: Aug. 28, 2014

(51) Int. Cl. H04L 29/06; H04L 9/32; G06F 21/60

(52) U.S. Cl. CPC H04L 63/0209; H04L 63/20; H04L 63/0428; G06F 21/602; H04L 63/0823; H04L 9/3265; H04L 9/3268

(57) ABSTRACT

A security device enables direct communications between devices operating at different security levels. The security device receives data from a first device operating at a first security level. The data is secured at the first security level and is intended for a second device operating at a second security level that is different than the first security level. The security device determines whether a condition permitting transmission from the first device to the second device is satisfied. In response to determining that the condition is satisfied, the security device adjusts a security level associated with the data and transmits, to the first device, the data with the adjusted security level.

### BACKGROUND OF THE INVENTION

Each communication device in a network may include a set of security features, wherein one or more of the communication devices in the network may include security features that meet a predefined set of requirements. For example, one or more of the communication devices in the network may include security features that provide a specialized set of encryption algorithms and other cryptographic algorithms (for example, support for Suite B algorithms), data protection, and storage features (for example, hardware encrypted storage). Communication devices including security features that meet the predefined set of requirements are referred to herein as high assurance devices. A non-limiting example of a high assurance device may include a communication device that can execute Suite B cryptographic algorithms using 384-bit or 512-bit elliptic curve cryptography (ECC) algorithms and Advanced Encryption Standard (AES) AES-256 and that can perform robust authentication and validation.

On the other hand, communication devices in the network that do not include security features that meet the predefined set of requirements are referred to herein as low assurance devices. Non-limiting examples of low assurance devices may include personal devices such as a cell phone, a personal computer, or digital glasses. Due to costs associated with the predefined set of requirements, high assurance devices are typically more costly than low assurance devices. To manage cost, it is possible for an organization to operate both high assurance devices and low assurance devices. In some situations, it may be necessary for a high assurance device to communicate with a low assurance device. However, devices operating on different security levels (for example, a high assurance device vs. a low assurance device) cannot communicate directly with each other. To overcome this problem, a high assurance device may be configured to include both the predefined set of requirements for high assurance devices and the security features included in low assurance devices. For example, if AES-256 is one of the security features required in high assurance devices and if a low assurance device only includes Advanced Digital Privacy (ADP) algorithms, the high assurance device may be configured to include both the AES-256 and ADP algorithms and may be configured to switch between the AES-256 and ADP algorithms. Subsequent to switching to the ADP algorithm, the high assurance device may communicate with a low assurance device. However, to remain a high assurance device, the device must switch back to the AES-256 algorithm. In some cases, a user of the high assurance device may forget to switch back to the AES-256 algorithm and may accidently use the ADP and, thus, expose communications to and from the high assurance device to low security features.

In addition, commercially available cryptographic solutions are generally not certified for high assurance systems/applications and are thus not capable of handling cryptographic keys for high assurance systems/applications. Current systems that are available for key generation or other cryptographic functions are also not applicable to high assurance devices. Current systems also do not permit mixed security level implementation within a single security management system. It should be noted that although it is not typical to mix security levels within a single security management system, this combination is not forbidden by regulatory authorities. Current systems also do not leverage open Secure Sockets Layer (i.e., a security protocol that determines variables of the encryption for both a link and data being transmitted between a client and server) for high assurance cryptographic operations. Current systems also limit communications between devices with different trust chains.

Accordingly, there is a need for a method and apparatus for enabling interoperability between devices operating at different security levels and trust chains.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system used in accordance with some embodiments.

FIG. 2 is a block diagram of a security device used in accordance with some embodiments.

FIG. 3 is a flowchart of a method for enabling direct communications between devices operating at different security levels in accordance with some embodiments.

FIG. 4 is a flowchart of a method for enabling certificate authentication between devices including different certificates chains in accordance with some embodiments.

FIG. 5 is another block diagram of a system used in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to apparatuses and methods for enabling direct communications between devices operating at different security levels. A security device receives data from a first device operating at a first security level. The data is secured at the first security level and is intended for a second device operating at a second security level that is different than the first security level. The security device determines whether a condition permitting transmission from the first device to the second device is satisfied. In response to determining that the condition is satisfied, the security device adjusts a security level associated with the data and transmits, to the first device, the data with the adjusted security level.

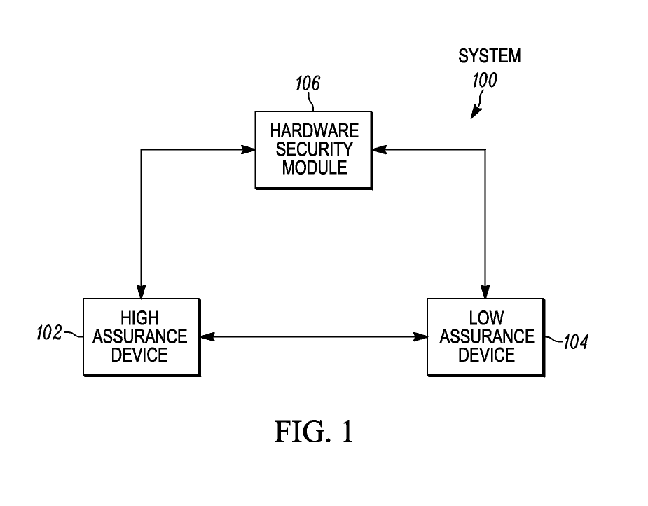

FIG. 1 is a block diagram of a system used in accordance with some embodiments. System 100 includes at least one communication device 102 with a predefined set of security features, wherein device 102 is referred to herein as operating at security level 1 and also is referred to as a high assurance device 102. In an embodiment, the set of security features in security level 1 may include, for example, an Advanced Encryption Standard (AES) AES-256 encryption algorithm. System 100 also at least one communication device 104 with another set of security features, wherein device 104 is referred to herein as operating at security level 2 and also is referred to as a low assurance device 104. A security feature in security level 2 may include, for example, an AES-128 encryption algorithm. The security features of security level 1 are typically higher than that of security level 2. It should be noted that the AES encryption algorithms are only provided as examples of security features that may be included in one or more security levels.

Although high assurance device 102 and low assurance device 104 include AES encryption algorithms, high assurance device 102 and low assurance device 104 may be unable to directly communicate with each other because, for example, the key length used in the encryption algorithms in high assurance device 102 and low assurance device 104 are different. In order for devices operating on different security levels to communicate with each other, each device may send information to be transmitted to the other device to a hardware security module (HSM) 106 (also referred to herein as a cryptographic device or as a security device 106). The information sent between devices operating on different security levels may include, for example, voice transmission and/or other data, wherein the information transmitted between the devices are referred to herein as data.

HSM 106 is a physical, tamper resistant, computing device that is configured to safeguard and manage digital keys for authentication and provide cryptographic processing such as encryption, decryption and digital signing. HSM 106 may provide a mechanism for enabling devices of different security levels to send information to and receive information from each other. HSM 106 also is configured to store key pairs for different security levels, and may appropriately elevate or de-elevate security levels. The security level controls provided by HSM 106 ensure that one device does not gain unauthorized access to a security level.

HSM 106 may include rules for identifying when devices operating at different security levels can communicate. Non-limiting examples of rules that may be included in HSM 106 may include one or more rules indicating that one or more conditions must be met for HSM 106 to allow data to be transmitted from a low assurance device to a high assurance device, and vice versa, and/or one or more rules indicating one or more conditions must be met before HSM 106 can authenticate devices with different trust chains. For example, HSM 106 may include a rule indicating that after receiving an alert signal, HSM 106 may allow data to be transmitted from low assurance device 104 to high assurance device 102. In another example, HSM 106 may include one or more rules indicating that HSM 106 may allow transfer of information to a lower security level in an emergency situation, for example, when an emergency button is pressed on a high assurance device. In another example, HSM 106 may include a rule indicating that HSM 106 may allow data to be transmitted from high assurance device 102 to low assurance device 104, regardless of the operating condition.

Accordingly, subsequent to receiving data from a device operating at one security level that is to be transmitted to a device operating at another security level, HSM 106 determines whether a condition that satisfies a rule for allowing devices operating at different security levels to communicate has occurred. For example, HSM 106 may determine whether an alert signal has been received. If a condition that satisfies one or more rules for allowing devices operating at different security levels to communicate has occurred, HSM 106 may determine the security level of the sending and receiving devices and adjust the security level on the data so that sending and receiving devices operating at different security levels can communicate, without either device having to change its security features.

Consider an example where high assurance device 102 has data that is to be sent to low assurance device 104. In an embodiment, high assurance device 102 may send data to be transmitted to low assurance device 104 to HSM 106. The data sent from high assurance device 102 is protected with features included in security level 1 (i.e., the security level of high assurance device 102). HSM 106 determines whether a condition that satisfies one or more rules for allowing devices operating at different security levels to communicate has occurred. For example, HSM 106 may determine that a rule exists that indicates that HSM 106 may allow data to be transmitted from high assurance device 102 to low assurance device 104, regardless of the operating condition. HSM 106 may determine the security level of high assurance device 102 and may wrap/format the data received from high assurance device 102 (i.e., the data protected with features from security level 1) using a different security level, for example, security level 3. Security level 3 may be, for example, a security level associated with sending data over a public network such as the Internet. HSM 106 sends the data formatted using security level 3 to high assurance device 102. In this example, both high assurance device 102 and low assurance device 104 may be configured to send and receive data formatted with security level 3.

High assurance device 102 thereafter sends the data formatted using security level 3 to low assurance device 104. Subsequent to receiving the data, low assurance device 104 may determine that it cannot decipher the underlying data which is still at security level 1 (i.e., the security level of high assurance device 102). Low assurance device 104 may therefore send the data to HSM 106 for HSM 106 to convert the data from security level 1 to security level 2. Subsequent to receiving the data from low assurance device 104, HSM 106 determines the security level of low assurance device 104, unwraps the data from security level 3 back to its original security level (i.e., security level 1 of high assurance device 102), converts the data from security level 1 to security level 2 (i.e., the security level of low assurance device 104), and sends the data to low assurance device 104 so that low assurance device 104 may now access the data using the features of security level 2.

In another embodiment, when high assurance device 102 sends data to be transmitted to low assurance device 104 to HSM 106, upon determining that a rule permitting the transmission has been satisfied, HSM 106 retrieves encryption keys from high assurance device 102 and low assurance device 104. HSM 106 then converts the data received from high assurance device 102 (for example, data encrypted with AES-256) into data that can be deciphered by low assurance device 104 (for example, data encrypted with AES-128). HSM 106 returns the data encrypted with AES-128 to high assurance device 102. High assurance device 102 sends the data encrypted with AES-128 to low assurance device 104, wherein low assurance device may access the data using AES-128, the security feature supported in low assurance device 104.

In another embodiment, when high assurance device 102 sends data to be transmitted to low assurance device 104 to HSM 106, subsequent to determining that a rule permitting the transmission has been satisfied, HSM 106 determines the security level of high assurance device 102. HSM 106 then formats the data received from high assurance device 102 with, for example, AES-256—the encryption level of high assurance device 102. HSM 106 returns the data protected with AES-256 security features to high assurance device 102. High assurance device 102 sends the data encrypted with AES-256 security features to low assurance device 104. Low assurance device 104 sends the data protected with AES-256 security features to HSM 106. HSM 106 determines the security level of low assurance device 104. HSM 106 removes the AES-256 security features from the data, formats the data with, for example, AES-128 security features (i.e., the security level of low assurance device 104), and sends the data protected with the AES-128 security features to low assurance device 104, wherein low assurance device may access the data using AES-128, i.e., the security feature supported in low assurance device 104.

In another embodiment, HSM 106 is configured to provide security level protection by utilizing a message tag with an appropriate token authentication. In this embodiment, subsequent to receiving data from, for example, high assurance device 102 and determining that the received data is to be converted to another security level (for example, security level 2), HSM 106 determines the security level of high assurance device 102 and verifies that high assurance device 102 may convert data from its security level to the security level of a receiving device, for example, low assurance device 104. HSM retrieves or creates a security key pair at security level 2 and formats the data with the level 2 security key. HSM 106 also signs a HSM message that includes the data formatted with the level 2 security key and sends the signed HSM message to high assurance device 102. The HSM message may include a header with the information on the security level of high assurance device 102 and low assurance device 104. The HSM message also includes the HSM secured data (i.e., the data that is secured with the level 2 security key) and the HSM signature. High assurance device 102 may thereafter send the HSM message to low assurance device 104, wherein the low assurance device may authenticate the HSM message and access the data using the level 2 security key, i.e., the security feature supported in low assurance device 104.

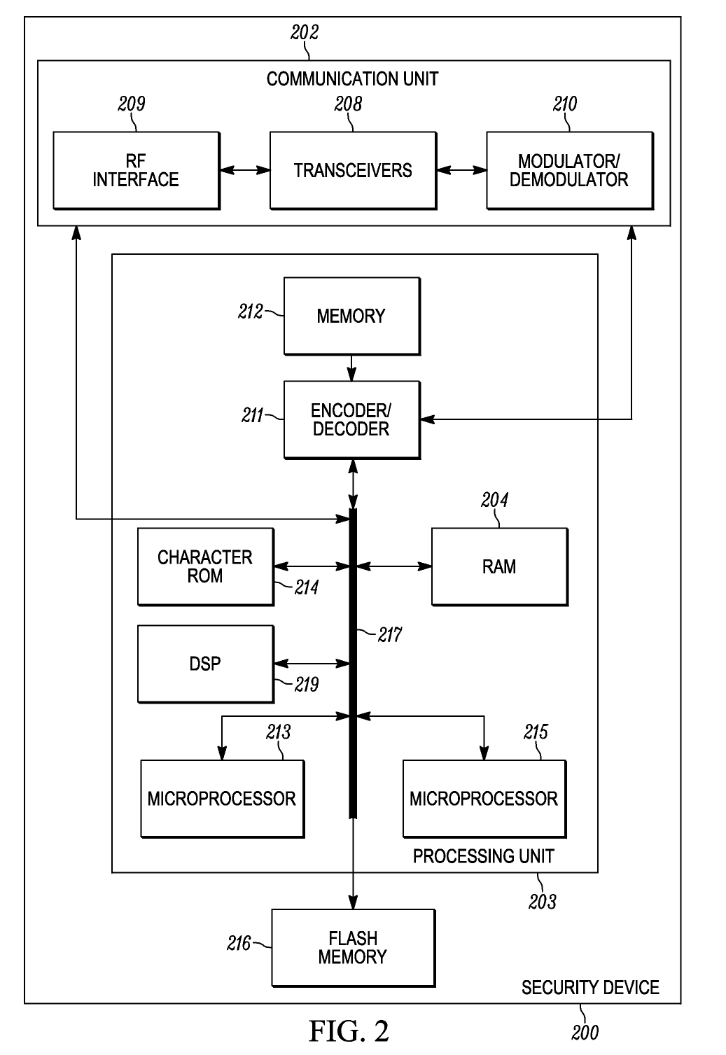

FIG. 2 is a block diagram of a security device 200, such as hardware security module 106, used in accordance with some embodiments. Security device 200 is a cryptographic device that may include, for example, a communications unit 202 coupled to a common data and address bus 217 of a processor 203. The processor 203 may include, that is, implement, an encoder/decoder 211 with an associated non-volatile memory 212 for storing data for encoding and decoding voice, data, control, or other signals that may be transmitted or received by security device 200. The processor 203 may further include one or more of microprocessors (for example, microprocessors 213 and 215) and digital signal processor (DSP) 219 coupled, by the common data and address bus 217, to the encoder/decoder 211 and to one or more memory devices, such as a character ROM 214, a random access memory (RAM) 204, and a flash memory 216. One or more of ROM 214, RAM 204 and flash memory 216 may be included as part of processor 203 or may be separate from, and coupled to, processor 203.

The encoder/decoder 211 may be implemented by one or more of microprocessors (for example, microprocessors 213 and 215) or DSP 219, or may each be implemented by a separate component of processor 203 and coupled to other components of processor 203 via bus 217. One or more of microprocessors 213 and 215 may provide redundant computation of the cryptographic data to insure high assurance is maintained. In an event where there is a difference in values computed by one or more microprocessors (for example, microprocessors 213 and 215), processor 203 may be configured to place security device 200 in a fail safe mode.

Communications unit 202 may include an RF interface 209 configurable to communicate with network components and other user equipment within its wireless communication range. Communications unit 202 may include one or more broadband and/or narrowband transceivers 208, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 202 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 210 that is coupled to the encoder/decoder 211.

Communications unit 202 is also configurable to communicate with other unlisted communication protocols. The modularity of the security device 200 permits for different protocols to be inserted or updated without changes to the underlying cryptographic function which determines the assurance level of a communications device (i.e., whether a communications device is a high or low assurance device).

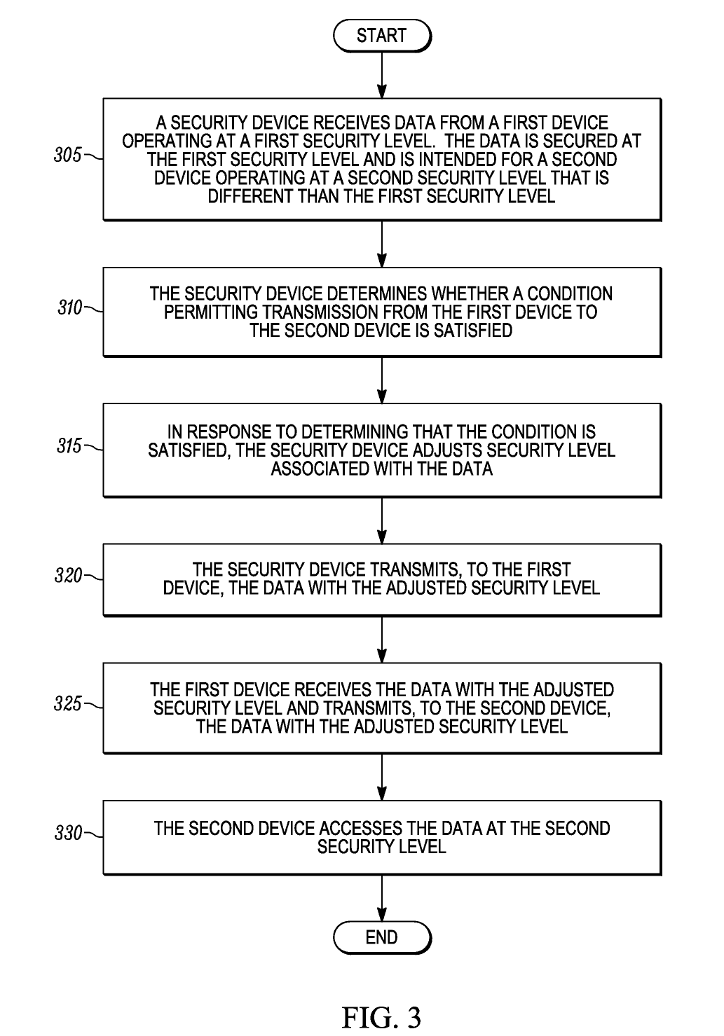

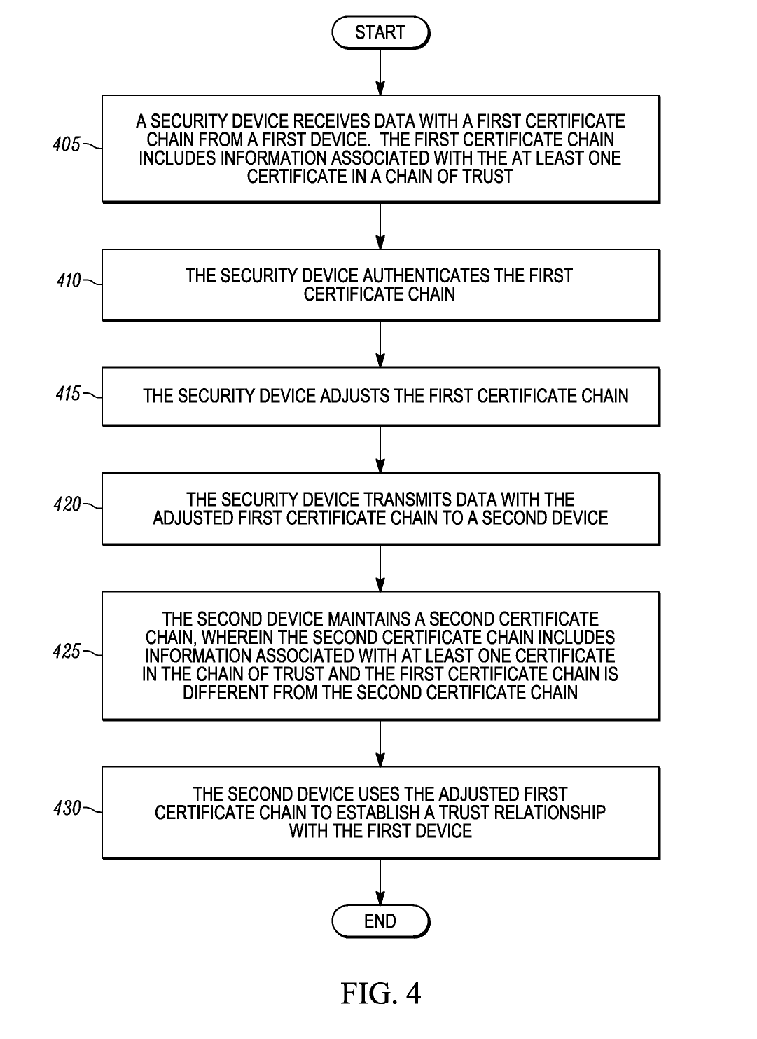

The one or more memory devices 204, 212, 214, 216 store code for decoding or encoding data such as control, request, or instruction messages, channel change messages, and/or data or voice messages that may be transmitted or received by security device 200 and other programs and instructions that, when executed by the processor 203, provide for the security device 200 to perform the functions and operations described herein as being performed by such a device, such as the implementation of the encoder/decoder 211 and one or more of the steps set forth in FIGS. 3 and 4.

FIG. 3 is a flowchart of a method for enabling direct communications between devices operating at different security levels in accordance with some embodiments. At 305, a security device, such as HSM 106, receives data from a first device operating at a first security level. The data is secured at the first security level and is intended for a second device operating at a second security level that is different than the first security level. At 310, the security device determines whether a condition permitting transmission from the first device to the second device is satisfied. At 315, in response to determining that the condition is satisfied, the security device adjusts a security level associated with the data. At 320, the security device transmits, to the first device, the data with the adjusted security level. At 325, the first device receives the data with the adjusted security level and transmits, to the second device, the data with the adjusted security level. At 330, the second device accesses the data at the second security level.

Digital certificates are verified using a chain of trust, wherein a digital certificate may be used prove ownership of a public key associated with the certificate. A trust anchor for a digital certificate is a root Certificate Authority (CA). The digital certificate includes, among other information, information about one or more entities that verified the certificate's contents. The chain of trust of a certificate chain is an ordered list of certificates including an end-entity (device) certificate, intermediate certificates that represent intermediate CA(s), and the certificate for the root CA. The chain of trust enables a relying device to verify that a certificate for a sending device and all intermediate and root certificates in the chain are trustworthy.

In an embodiment, returning to FIG. 1, one or more devices in system 100, for example, device 104, may have limitations on certificate storage and/or validation of a certificate throughout the entire/full chain of trust. For instance, a communication device with limitations on certificate storage may be allowed to store one or more certificates in a chain that is less than the full chain of trust. Consider, for example, that device 104 may be configured to store an end entity certificate and its immediate issuing certificate (CA1), even when there are more intermediate certificates in the chain of trust all the way up to the root CA. Although there may be system infrastructure with more resources that may be configured to store a full chain of trust, i.e., the certificate chain from an end entity up to the root CA, if device 104 does not have the resources to store the full chain of trust, device 104 will be unable to communicate with the system infrastructure because device 104 will be unable verify the full chain of trust using the certificate information stored on device 104. Accordingly, by storing a shorter certificate chain than the full chain of trust, device 104 is limited in its interoperability with devices that store the entire chain of trust.

Consider also, for example, that device 102 is configured to store the full chain of trust. Even if device 102 and device 104 are operating on the same security level, device 102 and device 104 will unable to communicate directly because they store different chains of trust. Therefore, device 104 may establish a first tunnel with HSM 106 and may send encrypted data with the shorter certificate chain to HSM 106. HSM 106 is configured to store all the certificates needed in certificate chain(s). HSM 106 may validate the certificates up the chain(s), and then vouch or re-sign the certificate with its own certificate (to make the chain of trust a “chain of one” so that device 104 can validate the chain).

In an embodiment, subsequent to receiving the shorter certificate from device 104, HSM 106 is configured to authenticate device 104 and to decrypt the data. HSM 106 may establish a second tunnel with device 102, associate the data with the longer certificate chain, and send the data to device 102. Device 102 can thereafter authenticate device 104 and decrypt the data sent from device 104 via HSM 106 because device 102 includes the full certificate chain as provided in the information sent from HSM 106. Accordingly, in this embodiment, HSM 106 serves as an interpreter, wherein device 104 establishes a first tunnel with HSM 106, device 104 sends data to HSM 106 via the first tunnel, HSM 106 authenticates the sender, HSM 106 decrypts the data and converts the data to a format understandable to device 102, HSM 106 establishes a second tunnel with device 102, and HSM 106 sends the converted data to device 102 on the second tunnel. It should be noted that the functions described herein could be implemented on one or more HSMs with shared certificates.

In another embodiment, rather than serving as an interpreter, HSM 106 may authenticate a certificate received from device 104, sign the certificate received from device 104, and send the signed certificate to device 102 to vouch for device 104. Subsequent to receiving the signed certificate from HSM 106, device 102 establishes a trust relationship with device 104 without further authenticating the certificate of device 104.

FIG. 4 is a flowchart of a method for enabling certificate authentication between devices including different certificates chains in accordance with some embodiments. At 405, a security device, such as HSM 106, receives data with a first certificate chain from a first device. The first certificate chain includes information associated with at least one certificate in a chain of trust. At 410, the security device authenticates the first certificate chain. At 415, the security device adjusts the first certificate chain. At 420, the security device transmits the data with the adjusted first certificate chain to a second device. At 425, the second device maintains a second certificate chain. The second certificate chain includes information associated with at least one certificate in the chain of trust and the first certificate chain is different from the second certificate chain. At 430, the second device uses the adjusted first certificate chain to establish a trust relationship with the first device.

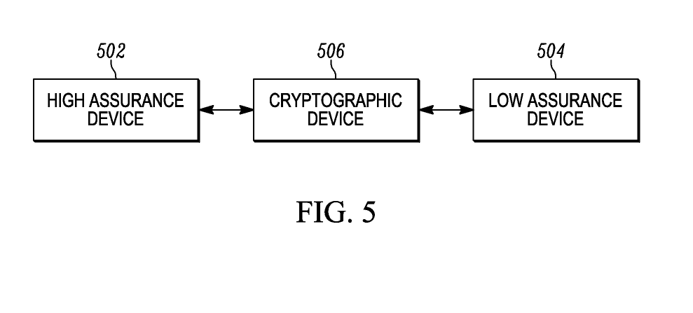

FIG. 5 is another block diagram of a system used in accordance with some embodiments. Cryptographic device 506 (such as HSM 106) may provide security level separation using software or hardware. For example, cryptographic device 506 may provide security level separation based on message tags, port numbers on the same physical Ethernet port, or a network interface card. Cryptographic device 506 may also provide security level separation using, for example, separate physical Ethernet ports or network interface cards, separate processors, or separate memory in physically separate configuration. The data transfer between security levels/processors may be carried out over an established protocol that may be monitored using a third independent processor. Accordingly, in an embodiment, cryptographic device 506 may be configured to permit or deny access to different security levels or networks based on one or more protocols as defined by, for example, user configuration or established rules.

Consider an example, where a high assurance device 502 sends a message intended for a low assurance device 504 to cryptographic device 506 and high assurance device 502 does not want to receive a low assurance message that is associated with its high assurance message from cryptographic device 506. Based on one or more protocols being implemented on cryptographic device 506, cryptographic device 506 may forward the low assurance message per user or system configuration and/or protocol changes required for low assurance device 504. For example, cryptographic device 506, through system configuration, hardware, and/or other rules, may determine how the incoming message is to be handled and what conditions may be applied to transmit the message to low assurance device 504 without having to interact with or further transmit the message via high assurance device 502. In this instance, cryptographic device 506 may be configured to receive the message from high assurance device 502, in a format specified by high assurance device 502, and to forward the message to low assurance device 504, without interaction with high assurance device 502.

Subsequent to receiving the message from high assurance device 502, cryptographic device 506 may extract data and relevant information from the received message and repackage/format (including perform cryptographic operations, if required) the message into a format that low assurance device 504 is capable of accessing. This formatting may include, and is not limited, to re-signing of the data within the message, and/or changing the message protocol, for example, changing from an IP protocol to a Secure Digital Input Output (SDIO) protocol. Cryptographic device 506 may be configured to permit or prevent any protocols and may be configured to prevent or enable reformatting of messages, as required or requested within pre-assigned or requested conditions. This allows for physical and/or logical separation between two or more networks through cryptographic device 506, wherein cryptographic device 506 being a member of the two or more networks may act as a bridge between the networks and may “hide” the network details from transmitters and/or receivers.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for enabling direct communications between devices operating at different security levels, the method comprising:
receiving, by a security device, data from a first device operating at a first security level, wherein the data is secured at the first security level and is intended for a second device operating at a second security level that is different than the first security level;
determining, by the security device, whether a condition permitting transmission from the first device to the second device is satisfied;
in response to determining that the condition is satisfied, adjusting, by the security device, a security level associated with the data;
transmitting, by the security device to the first device, the data with the adjusted security level.

2. The method of claim 1, further comprising:
receiving, by the first device, the data with the adjusted security level;
transmitting, by the first device to the second device, the data with the adjusted security level; and
accessing, by the second device, the data at the second security level.

3. The method of claim 1, wherein adjusting comprises:
in response to determining that the condition is satisfied, retrieving, by the security device, at least one of an encryption key of at least one of the first device and the second device and the security level of at least one of the first device and the second device; and
converting an encryption level of the data from a first encryption level used by the first device to a second encryption level used by the second device.

4. The method of claim 1, wherein adjusting comprises:
formatting the data using features of a third security level, wherein the first device and the second device are configured to send and receive data formatted using the features of the third security level and wherein the third security level is different than the first and second security levels.

5. The method of claim 4, further comprising:
subsequent to the transmission of the data with the adjusted security level to the first device, receiving, by the security device from the second device, the data formatted using the features of the third security level;
determining, by the security device, that the second device supports the second security level;
reformatting, by the security device, the data to the first security level;
converting, by the security device, the data from the first security level to the second security level; and
transmitting, by the security device, the converted data to the second device.

6. The method of claim 1, wherein adjusting comprises:
formatting, by the security device according to a request from the first device, the data received from the first device and secured at the first security level into data secured at the second security level.

7. The method of claim 6, wherein formatting the data secured at the second security level comprises:
retrieving, by the security device, a security key pair at the second security level;
formatting, by the security device, the data with a security key of the security key pair;
including the data in a message signed by the security device; and
wherein transmitting comprises transmitting the message to the first device.

8. A method for enabling certificate authentication between devices including different certificates chains, the method comprising:
receiving, by a security device, data with a first certificate chain from a first device, wherein the first certificate chain comprises information associated with at least one certificate in a chain of trust;
authenticating, by the security device, the first certificate chain;
adjusting, by the security device, the first certificate chain; and
transmitting, by the security device, the data with the adjusted first certificate chain to a second device.

9. The method of claim 8, further comprising:
maintaining, by the second device, a second certificate chain, wherein the second certificate chain includes information associated with at least one certificate in the chain of trust and wherein the first certificate chain is different from the second certificate chain; and
utilizing, by the second device, the adjusted first certificate chain to establish a trust relationship with the first device.

10. The method of claim 9, wherein adjusting comprises converting the first certificate chain to the second certificate chain, and wherein the method further comprises:
establishing, by the second device, a trust relationship with the first device by authenticating the converted first certificate chain using the second certificate chain.

11. The method of claim 10, wherein adjusting comprises re-signing, by the security device, the first certificate chain and wherein the second device establishes the trust relationship with the first device by authenticating the signature of the adjusted first certificate chain.

12. The method of claim 8, wherein authenticating comprises:
validating certificates in the first certificate chain with certificates stored on the security device.

13. The method of claim 8,
wherein receiving data from the first device comprises establishing, by the security device, a first tunnel with the first device and receiving the data from the first device via the first tunnel; and
wherein transmitting comprises establishing, by the security device, a second tunnel with the second device and transmitting the data with the adjusted first certificate chain to the second device via the second tunnel.

14. An apparatus for enabling direct communications between devices operating at different security levels, the apparatus comprising:
a cryptographic device comprising:
a memory;
a transceiver for receiving data from a first device operating at a first security level, wherein the data is secured at the first security level and is intended for a second device operating at a second security level that is different than the first security level;
a processor configured to implement a security device that performs a set of functions comprising:
determining whether a condition permitting transmission from the first device to the second device is satisfied; and
in response to determining that the condition is satisfied, adjusting the security level associated with the data;
wherein the security device further is configured to transmit, via the transceiver, the data with the adjusted security level to at least one of the first device and the second device.

15. The apparatus of claim 14, further comprising the first device and the second device,
wherein the first device is configured to:
receive the data with the adjusted security level;
transmit, to the second device, the data with the adjusted security level; and
wherein the second device is configured to:
access the data at the second security level.

16. The apparatus of claim 14, wherein the set of functions are configured to adjust the security level by:
in response to determining that the condition is satisfied, retrieving, from the memory, at least one of an encryption key of at least one of the first device and the second device and the security level of at least one of the first device and the second device; and
converting an encryption level on the data from a first encryption level used by the first device to a second encryption level used by the second device.

17. The apparatus of claim 14, wherein the set of functions are configured to adjust the security level by:
formatting the data using features of a third security level, wherein the first device and the second device are configured to send and receive data formatted using the features of the third security level and wherein the third security level is different than the first and second security levels.

18. The apparatus of claim 17, wherein the set of functions further comprise:
subsequent to the transmission of the data with the adjusted security level to the first device, receiving the data formatted using the features of the third security level from the second device subsequent to transmission of the data from the first device to the second device;
determining the security level of the second device,
reformatting the data to the first security level;
converting the data from the first security level to the second security level; and
transmitting the converted data to the second device.

19. The apparatus of claim 14, wherein the set of functions are configured to adjust the security level by:
formatting the data received from the first device at the first security level, according to a request from the first device, into data secured at the second security level.

20. The apparatus of claim 14, wherein the set of functions are configured to format the data by:
retrieving a security key pair at the second security level;
formatting the data with the security key; and
including the data in a message signed by the security device, and
wherein the security device is configured to transmit the data by transmitting the message with the data to the first device.

21. The apparatus of claim 14, further comprising a fourth device, wherein the set of functions further comprise:
receiving data with a first certificate chain from a third device, wherein the first certificate chain comprises information associated at least one certificate in a chain of trust;
authenticating the first certificate chain;
adjusting the first certificate chain; and
transmitting the data with the adjusted first certificate chain to the fourth device; and
wherein the fourth device is configured to:
maintain a second certificate chain, wherein the second certificate chain includes information associated with at least one certificate in the chain of trust and wherein the first certificate chain is different from the second certificate chain; and
utilize, by the fourth device, the adjusted first certificate chain to establish a trust relationship with the third device.

22. The apparatus of claim 14, wherein the set of functions are configured to:
adjust the security level by formatting the data received from the first device at the first security level, according to at least one of a request from the first device, an operating protocol and an operating condition, into data secured at the second security level; and
transmit, via the transceiver, the data with the adjusted security level to the second device.
